(19) United States
(12) Patent Application Publication
(10) Pub. No.: US 2007/0185682 A1
(43) Pub. Date: Aug. 9, 2007

(54) Time-aware trigger distribution

(76) Inventor: John C. Eidson, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/348,741

(22) Filed: Feb. 6, 2006

(51) Int. Cl. G06F 15/00

(52) U.S. Cl. 702/178

(57) ABSTRACT

Trigger distribution with time-based control over the handling of trigger signals. A trigger distribution device according to the present teachings includes a timing subsystem that provides a time base for handling a set trigger signals that are distributed among a unit under test and a set of instruments.

### BACKGROUND

Automatic test equipment (ATE) systems may be used to examine large-scale devices or systems. A large-scale device or system that is the subject of an ATE system may be referred to as a unit under test (UUT). An ATE system may include a variety of instruments that apply stimuli to a UUT and a variety of instruments that measure the response of the UUT. Examples of instruments that may be employed in an ATE system are too numerous to mention but include oscilloscopes, spectrum analyzers, logic analyzers, signal detectors, signal generators, as well as specialized stimulus generators and specialized response sensors.

An instrument in an ATE may be capable of a variety of actions. One example of an action of an instrument is applying a stimulus to a UUT. Another example of an action of an instrument is measuring a response of a UUT. An instrument may include a set of trigger inputs for causing actions by the instrument. In addition, an instrument may include a set of trigger outputs for signaling its actions or other information to other portions of an ATE system.

A UUT may be capable of a variety of actions that may be examined using an ATE system. The actions performed by a UUT may depend on the nature of the UUT and an application of the UUT. A UUT may include a set of trigger inputs for causing actions by the UUT. A UUT may also include a set of trigger outputs for signaling its actions or other information to other portions of an ATE system.

An ATE system may include a set of trigger lines, e.g. coaxial cables, for carrying trigger signals from a set of trigger outputs of a UUT and a set of instruments to a set of trigger inputs of the UUT and the instruments. The routing of the trigger lines may be used to coordinate a test and measurement operation in an ATE system by distributing the appropriate trigger signals among a UUT and a set of instruments.

Test and measurement operations in an ATE system may include a number of different distributions of trigger signals among a UUT and a set of instruments. For example, one phase of a test may require a distribution of a set of trigger signals between a UUT and one set of instruments while another phase of the test may require a distribution of the trigger signals between the UUT and another set of instruments or different connections to the same instruments. Trigger signals may be redistributed by physically disconnecting and reconnecting the trigger lines that carry the trigger signals. Unfortunately, such a method for redistributing trigger signals may be too time consuming for practical operation of an ATE system.

An ATE system may include a switch matrix that enables relatively rapid changes in the distribution of trigger signals. For example, a switch matrix may include a set of input ports that receive a set of trigger signals from a UUT and a set of instruments and may further include a set of output ports that provide trigger signals to the UUT and the instruments.

A prior switch matrix may create uncertainties in the propagation delays of trigger signals in an ATE system. For example, a propagation delay of a trigger signal from an instrument to a UUT may depend on a particular path that the trigger signal takes through a switch matrix. Unfortunately, uncertainties in the propagation delays of trigger signals may reduce the precision of test and measurement operations in an ATE system. In addition, designers of ATE systems may be forced to use a trial and error technique to “tune” the connections of trigger lines and cable lengths in order to achieve a desired timing result. Unfortunately, such a technique may be time consuming and expensive and prone to error. Moreover, such trial and error tuning of trigger lines may be highly dependant on the timing performance of the individual instruments and UUTs. Changes to the lengths of the connecting cables and changes to the instruments or a UUT may require a completely new tuning of the system.

### SUMMARY OF THE INVENTION

Trigger distribution with time-based control over the handling of trigger signals is disclosed. A trigger distribution device according to the present teachings includes a timing subsystem that provides a time base for handling a set trigger signals that are distributed among a unit under test and a set of instruments.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows an ATE system that includes a trigger distribution device according to the present teachings;

FIG. 2 shows one embodiment of a switch fabric in a trigger distribution device;

FIG. 3 shows circuitry for measuring the propagation delay of trigger signals inside a trigger distribution device in one embodiment;

FIG. 4 shows circuitry for measuring the propagation delay of trigger signals inside a trigger distribution device in another embodiment;

FIG. 5 shows circuitry for adjusting a propagation delay of trigger signals;

FIG. 6 shows a technique for measuring a propagation delay of a trigger signal inbound into a trigger distribution device;

FIG. 7 shows a technique for measuring a propagation delay of a trigger signal outbound from a trigger distribution device;

FIG. 8 shows an arming control circuit in a trigger distribution device.

### DETAILED DESCRIPTION

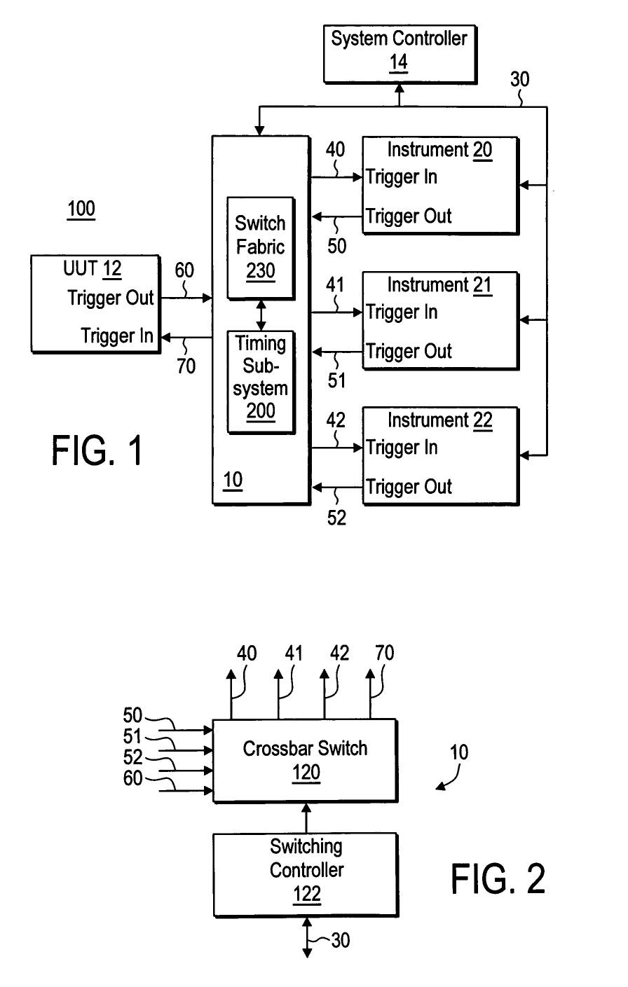

FIG. 1 shows an ATE system 100 that includes a trigger distribution device 10 according to the present teachings. The trigger distribution device includes a switch fabric 230 and a timing subsystem 200. The switch fabric 230 provides connectivity for trigger signals associated with a set of instruments 20-22 and a UUT 12. The timing subsystem 200 provides a time base for handling the trigger signals that are distributed among UUT 12 and the instruments 20-22. The time base in one embodiment is a global time base in the ATE system 100 based on a time synchronization protocol.

The ATE system 100 includes a system controller 14 that communicates with the instruments 20-22 and the trigger distribution device 10 via a local area network 30. In some embodiments, the local area network 30 also connects to the UUT 12.

The trigger distribution device 10 receives trigger signals from the instruments 20-22 via a set of trigger lines 50-52 and receives trigger signals from the UUT 12 via a set of trigger lines 60. The trigger distribution device 10 distributes the trigger signals to the instruments 20-22 via a set of trigger lines 40-42 and to the UUT 12 via a set of trigger lines 70. The switch fabric 230 provides full connectivity among the trigger lines 40-42, 50-52, 60 and 70.

The timing subsystem 200 includes circuitry that generates a timestamp in response to a change in the connectivity of the switch fabric 230. The timing subsystem 200 triggers a change in connectivity of the switch fabric 230 in response to a global time, e.g. at a preconfigured or a specified time.

The timing subsystem 200 includes circuitry that measures an internal propagation delay of one or more of the trigger signals inside the trigger distribution device 10. Trigger latency measurements avoid the guesswork in trigger latency that plagues prior art ATE systems.

The timing subsystem 200 includes circuitry that measures a time of receipt of one or more of the trigger signals using a global time base. The time of receipt enables a determination of a propagation delay on an inbound trigger line.

The timing subsystem 200 includes circuitry that measures an exit time of one or more of the trigger signals using a global time base. The exit time enables a determination of a propagation delay on an outbound trigger line.

The timing subsystem 200 includes circuitry that generates a calibration trigger signal. The calibration trigger signal enables a determination of a propagation delay on a trigger line in cooperation with an external device.

The timing subsystem 200 includes circuitry that adjusts an internal propagation delay of one or more of the trigger signals. An adjustment to the internal propagation delay may be specified with respect to a primary trigger event. A primary trigger event may be an absolute time specification or a time specification relative to an event determined at run-time or an electronic signal. The timing subsystem 200 includes circuitry that adjusts the internal propagation delay in response to application-specific requirements. The timing subsystem 200 includes circuitry that adjusts the internal propagation delay in response to a propagation delay on a set of trigger lines that carry one or more of the trigger signals.

The timing subsystem 200 in some embodiments includes circuitry that directly measures a propagation delay on the trigger lines 40-42, 50-52, 60, and 70. The measurement may be made using several techniques depending on the cable technology, e.g. coax, twisted pairs, optical fiber. For example, time domain reflectometry (TDR) may be used to measure propagation delay on a trigger line.

FIG. 2 shows one embodiment of the switch fabric 230 which includes a crossbar switch 120 and a switching controller 122. The crossbar switch 120 enables full connectivity among the trigger lines 40-42, 50-52, 60 and 70. The switching controller 122 includes circuitry for controlling the crossbar switch 120 and circuitry for generating a timestamp when the crossbar switch 120 is changed from one topology to another. In addition, the switching controller 122 includes circuitry for causing the crossbar switch 120 to change its topology based on time, e.g. using a time-based command, time script, etc. The time base for these operations in one embodiment is a time base that applies to all of the ATE system 100. One example of a system-wide time base is one based on the IEEE 1588 time synchronization protocol.

The timestamp and/or time-trigger functionality of the switching controller 122 may be implemented in software. In one embodiment, code executing in the switching controller 122 obtains a timestamp by reading a real-time clock that holds a global time. Similarly, code in the switching controller 122 reads the real-time clock when determining when it is time change the topology of the crossbar switch 120. Alternatively, a combination of hardware and software may be used for these time-aware functions. For example, timestamps may be captured by a hardware register, i.e. taking a snapshot of a hardware clock. Signals that change the topology of the crossbar switch 120 may be generated using a register that holds a time value and a comparator that compares a time from a hardware clock to the time value in the register.

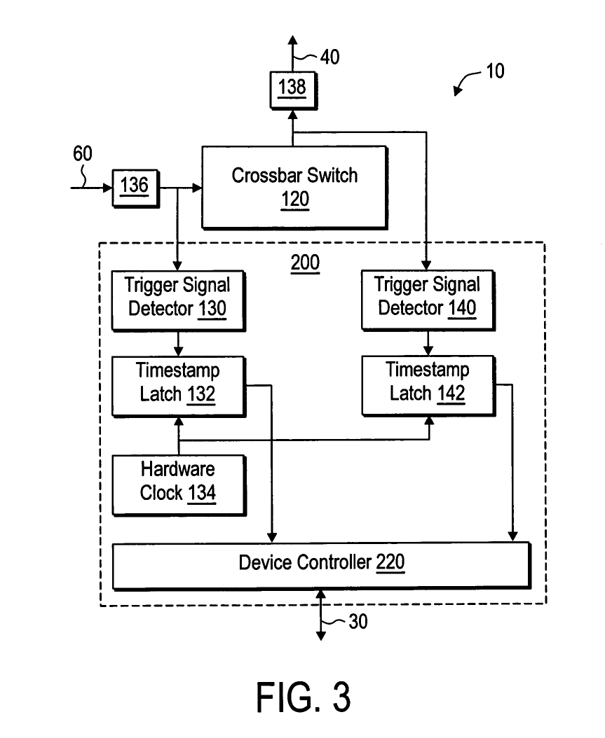

FIG. 3 shows circuitry in the timing subsystem 200 for measuring the propagation delay of trigger signals inside the trigger distribution device 10. The timing subsystem 200 includes a pair of trigger signal detectors 130 and 140, a pair of timestamp latches 132 and 142, and a hardware clock 134 for measuring the propagation delay between an input port 136 for the trigger line 60 and an output port 138 for the trigger line 40. Similar circuitry may be provided for the remaining input and output ports of the trigger distribution device 10.

The trigger signal detector 130 detects a trigger signal received via the input port 136. The trigger signal detector 130 causes the timestamp latch 132 to latch a time value from the hardware clock 134 when a trigger signal is detected at the input port 136. The contents of the timestamp latch 132 are provided to a device controller 220. The trigger signal detector 140 detects when the trigger signal received at the input port 136 reaches the output port 138 after propagating through its currently configured path through the crossbar switch 120. The trigger signal detector 140 causes the timestamp latch 142 to latch a time value from the hardware clock 134 when the trigger signal is detected at the output port 138. The contents of the timestamp latch 142 are provided to the device controller 220. The device controller 220 determines the propagation delay of the trigger signal in response to the timestamps from the timestamp latches 132 and 142.

The device controller 220 may send the measured propagation delay to the system controller 14 or other device via the local area network 30 for use in correcting other time related functions of the ATE system 100 or for use in analyzing the resulting data collected by the ATE system 100.

The hardware clock 134 may hold time that is synchronized according to a time synchronization protocol, e.g. IEEE 1588.

The total propagation delay of a trigger signal from the UUT 12 via the trigger line 60 through the trigger distribution device 10 and then via the trigger line 40 to the instrument 20 includes the propagation delay inside the trigger distribution device 10 plus the propagations delays on the trigger lines 40 and 60. An application in the ATE system 100 may use the total propagation delay in adjusting other parts of the timing of the ATE system 100.

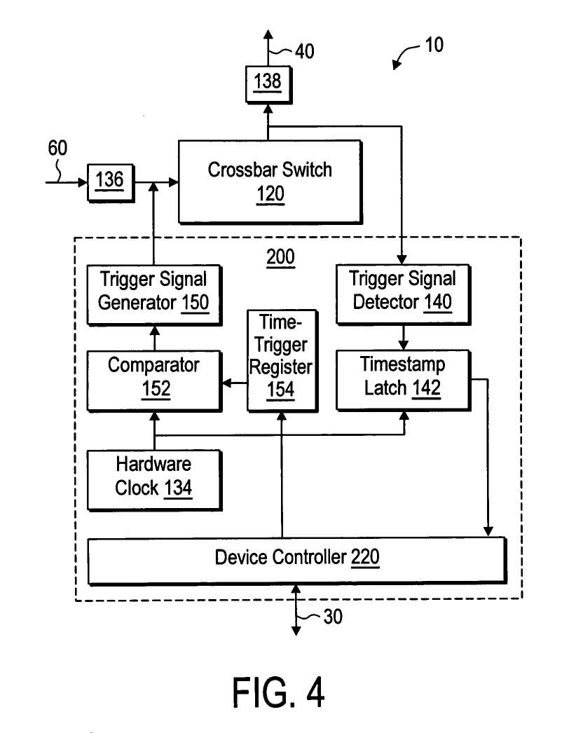

FIG. 4 shows circuitry in the timing subsystem 200 for measuring the propagation delay of trigger signals inside the trigger distribution device 10 in another embodiment. In this embodiment, the timing subsystem 200 includes a trigger signal generator 150 and a comparator 152 and a time-trigger register 154 for generating a trigger signal at the input port 136 inside the trigger distribution device 10 rather than use an externally generated trigger signal to measure the propagation delay. The device controller 220 loads a time value into the time-trigger register 154. When a time in the time-trigger register 154 agrees with a time in the hardware clock 134 the comparator 152 generates a signal that causes the trigger signal generator 150 to inject a trigger signal into the input channel at the input port 136. The injected trigger signal is then detected and time-stamped at the output channel so that the device controller 220 determines the propagation delay as previously described.

In another alternative, circuitry in the timing subsystem 200 for measuring the propagation delay of trigger signals inside the trigger distribution device 10 includes a high speed counter that is started by a trigger signal arriving at the input port 136. The high speed counter is stopped when the trigger signal is detected at the output port 138. The device controller 220 determines the propagation delay in response to the frequency of the clock that drives the high speed counter and the count value contained in the high speed counter.

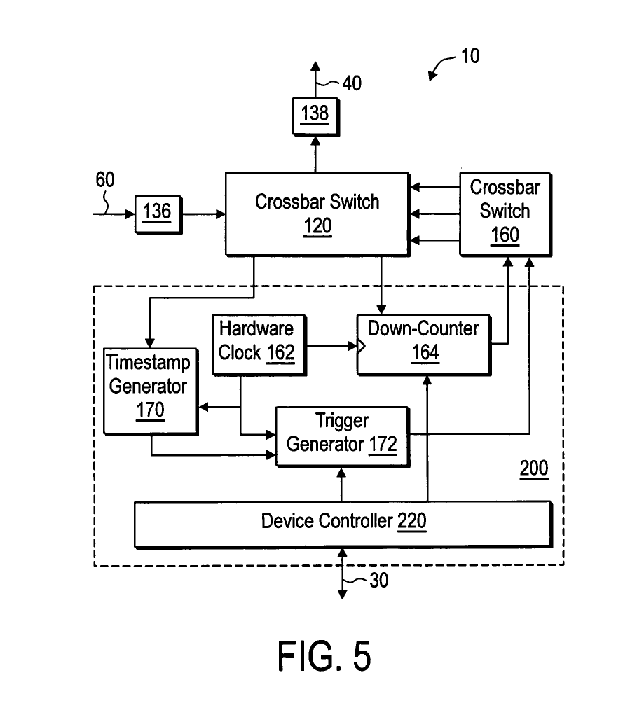

FIG. 5 shows circuitry in the timing subsystem 200 for adjusting the propagation delay of trigger signals in one embodiment. The circuitry in the timing subsystem 200 for delaying a trigger signal received at the input port 136 include a crossbar switch 160, a hardware clock 162, and a down-counter 164.

The lowest propagation delay through the trigger distribution device 10 is realized by routing the trigger signal from the input port 136 directly through the crossbar switch 120 to the output port 138. The actual amount of propagation delay in that path may be measured using the techniques previously described.

The propagation delay of a trigger signal received at the input port 136 is increased by routing the trigger signal through the crossbar switch 120 to the down counter 164 which is driven by the hardware clock 162. The terminal count of the down-counter 166 provides a delayed trigger signal that is routed through the crossbar switch 160 and through the crossbar switch 120 and to the output port 138. The value of the delay count is preset into the down-counter by the device controller 220.

A relatively large increase to the propagation delay of a trigger signal received at the input port 136 is realized by a timestamp generator 170 and a trigger generator 172. The trigger signal received at the input port 136 causes the timestamp generator 170 to generate a timestamp, e.g. by latching a time value from the hardware clock 162. The timestamp generator 170 generates a trigger time by adding a delay value to the timestamp and provides the trigger time to the trigger generator 172. The delay value is programmed into the timestamp generator 170 by the device controller 220. The trigger generator 172 generates a delayed trigger signal at a time specified by the trigger time from the timestamp generator 170, e.g. by monitoring the hardware clock 162.

The delay counts and delay values for adjusting the propagation delay inside the trigger distribution device 10 may be determined by subtracting the propagation delays on the trigger lines 40 and 60, in the above example, to produce a desired overall propagation delay for a trigger signal from the UUT 12 to the instrument 20 via the trigger lines 40 and 60 and the trigger distribution device 10.

Measurement devices may be placed at the input port 136 and the output port 138, in the above examples, that are capable of directly measuring the propagation delays on the trigger lines 60 and 40, respectively. For example, a time domain reflectrometry (TDR) circuit at the input port 136 may be used to directly measure the propagation delay on the trigger line 60. The measured propagation delay may be obtained by the device controller 220. This technique is appropriate when the UUT 12 output port connected to the trigger line 60 provides sufficient reflection for the TDR circuit and when the UUT 12 will not be damaged by the TDR measurement and when the effective point determining the remote end of the TDR measurement corresponds to the point at which the internal timing specifications of the UUT 12 are referenced.

The propagation delay information associated with the trigger lines 40-42, 50-52, 60, and 70 may be measured by cooperative action between the trigger distribution device 10 and the UUT 12 or between the trigger distribution device 10 and a special device placed at the UUT 12 end of a trigger line from the UUT 12. The cooperative actions may be coordinated by the system controller 14 or may initiated in a peer-to-peer manner. In one embodiment, the trigger distribution device 10 generates a calibration trigger signal used only for purposes of calibration. The UUT 12 or a special device receives the calibration trigger signal and generates a timestamp in response to the calibration trigger signal. A similar procedure may be used for propagation delays to the instruments 20-22.

In another embodiment, the UUT 12 or a trigger generating device generates a calibration trigger signal and a timestamp. The calibration trigger signal is received by the trigger distribution device 10 which generates a timestamp. The difference between these timestamps indicates the propagation delay and may be used to adjust subsequent timing performance of the corresponding trigger signal path. A similar technique can be used for trigger signals outbound from the trigger distribution device 10.

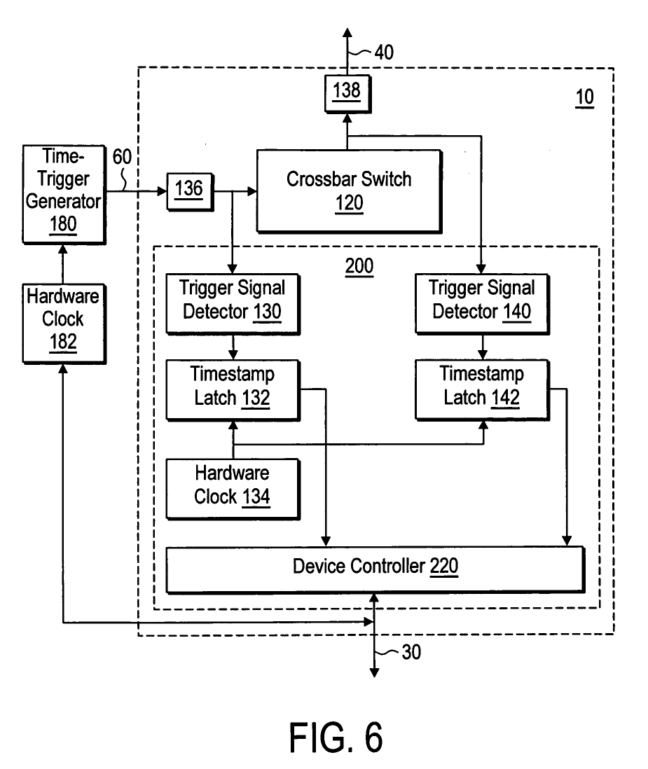

FIG. 6 shows a technique for measuring the propagation delay of a trigger signal inbound into the trigger distribution device 10 on a trigger line which in this example is the trigger line 60. In this embodiment, a time-trigger generator 180 generates a trigger signal on the trigger line 60 at time TG. The time-trigger generator 180 may be a special device inserted between the UUT 12 and the end of the trigger line 60 where it connects to the UUT 12. Alternatively, the time-trigger generator 180 may be contained within the UUT 12.

The time T_{G} for generating the trigger signal may be measured or specified. The arrival time of the trigger signal at the input port 136 is time-stamped in a manner previously described yielding a time stamp T_{GI}. The difference between T_{GI} and T_{G} is the propagation delay on the trigger line 60.

In a similar manner, a time-trigger generator may be placed on a trigger line associated with an instrument or within an instrument itself to measure propagation delays on trigger lines associated with instruments.

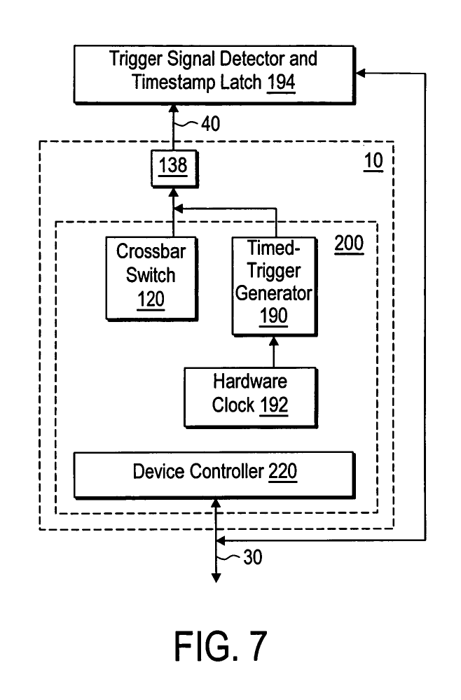

FIG. 7 shows a technique for measuring the propagation delay of a trigger signal outbound from the trigger distribution device 10 on a trigger line which in this example is the trigger line 40. The timing subsystem 200 in this embodiment includes a timed-trigger generator 190 that generates a trigger signal on the trigger line 40 at a time T_{G} using a hardware clock 192. The trigger signal is detected by a trigger signal detector and timestamp latch 194 that in response generates a timestamp T_{GR} using the global time base in the ATE system 100. The difference between T_{GR} and T_{G} is the propagation delay on the trigger line 40 when properly corrected for any residual latency within the trigger distribution device 10 and the instrument 22. The trigger signal detector 194 may be placed between the end of the trigger line 60 and the instrument 22 or within the instrument 22.

Alternatively, propagation delays on the trigger lines to and from the trigger distribution device 10 may be measured by generating timestamps based on the global time base of the ATE system 100 using trigger detectors and timestamp generators at the appropriate places and using trigger signals generated by the UUT 12 and the instruments 20-22 during normal test and measurement operations.

The propagation delay information may be determined by measuring the length of the connecting cables or by using calibrated cables. The propagation delay information may be read from a memory in a cable. The propagation delay information may be made available to the system controller 14 programmatically via an information interface and used to adjust the timing internal to the trigger distribution device 10 for each trigger path between the UUT 12 and the instruments 20-22.

The timing subsystem 200 includes an arming mechanism for enforcing selected types of timing performance. A centralized arming mechanism in the trigger distribution device 10 enables arming based on a number of conditions involving multiple ones of the instruments 20-22 simultaneously. An arming mechanism may be implemented in the trigger distribution device 10 on its input ports, its output ports, or as part of its switching fabric. The inputs to an arming state machine in the trigger distribution device 10 may be combinations of signals input to the trigger distribution device 10, driver calls from a controller, based on the local hardware clock synchronized to the system time base, etc. or various combinations.

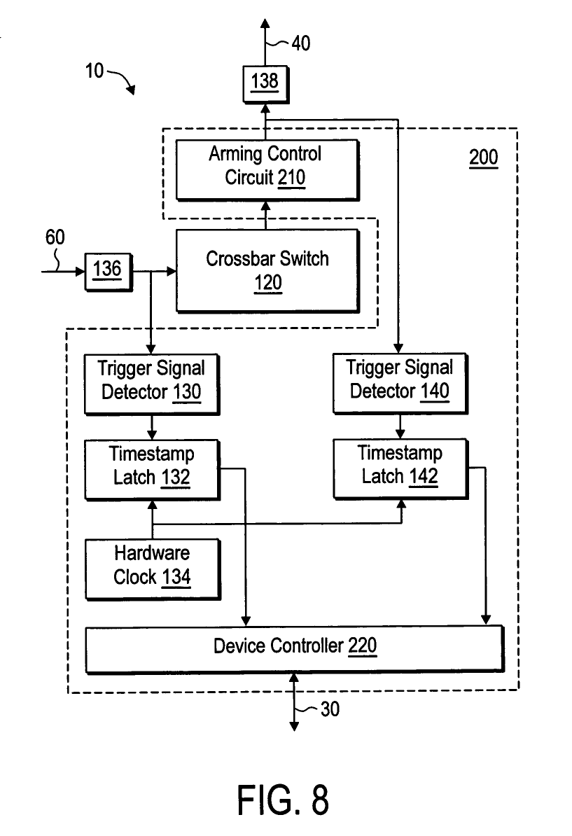

FIG. 8 shows an arming control circuit 210 in the timing subsystem 200. The arming control circuit 210 implements Boolean logic of an arming state machine. The arming control circuit 210 blocks, e.g. using switches, trigger signals from exiting the crossbar switch 120 unless the arming state machine is in a trigger state for the trigger signal in question. For example, the arming control circuit 210 blocks a trigger signal received via the trigger line 60 from exiting the crossbar switch 120 to the trigger line 40 unless the arming state machine in the arming control circuit 210 is in a trigger state for that trigger signal.

The inputs to the arming state machine in the arming control circuit 210 may have a variety of sources. In one embodiment, the inputs to the arming state machine include trigger signals that exit the crossbar switch 120. This may be used, for example, to arm after the occurrence of 42 trigger signals destined for the trigger line 40, or another trigger signal exiting the crossbar switch 120 including signals derived from other input ports of the trigger distribution device 10, or signal from the device controller 220. Other embodiments may include time based arming in which a time-trigger signal provides an input to the arming state machine. In addition, an arming function may span multiple trigger signals exiting the crossbar switch 120 to different output ports of the trigger distribution device 10. An arming function may be based on a message received via the local area network 30. An arming function may be associated with each of a set of output ports of the trigger distribution device 10.

The time-aware mechanisms in the trigger distribution device 10, e.g. the mechanisms for measuring propagation delays and adjusting propagation delays, may be implemented to very high accuracy. Propagation delays may be measured internal to the trigger distribution device 10 without reference to an external time base, thereby enabling higher accuracy than may be available using in synchronized clocks for a global time base.

On the other hand, a global time base, e.g. using IEEE 1588 clocks, in the trigger distribution device 10 and the UUT 12 and the instruments 20-22 enables events in the trigger distribution device 10 to be referenced to a global time base. For example, changes in switching topology may be referenced to a global time base. In addition, measurements of propagation delays that employ devices external to the trigger distribution device 10 may also be reference to a global synchronized time base.

The trigger distribution device 10 facilitates transportability of an ATE system. For example, the important timing relationships that pertain to a UUT may change when moving the UUT to a new or upgraded ATE system. The trigger distribution device 10 facilitates measuring the timing properties in an ATE system. In addition, the trigger distribution device 10 enables a system controller to specify a desired timing which is realized using the mechanism disclosed above. The trigger distribution device 10 enables system integrators to devise programs as part of a test suite that measure, specify and correct for the actual timing of the trigger signals. This enables an ATE system to adapt to timing changes caused by, for example, the replacement of a cable with one of different length, a change in the timing performance of one of the instruments, a change in execution speed in a system controller when it is upgraded to a newer model, or changes in the required timing specifications for a test.

The foregoing detailed description of the present invention is provided for the purposes of illustration and is not intended to be exhaustive or to limit the invention to the accurate embodiment disclosed. Accordingly, the scope of the present invention is defined by the appended claims.

What is claimed is:

1. A trigger distribution device, comprising:
circuitry that provides a connectivity among a set of trigger signals from a unit under test and a set of instruments;
timing subsystem that provides a time base for handling the trigger signals within the trigger distribution device.

2. The trigger distribution device of claim 1, wherein the timing subsystem generates a timestamp in response to a change in the connectivity.

3. The trigger distribution device of claim 1, wherein the timing subsystem triggers a change in the connectivity in response to a global time.

4. The trigger distribution device of claim 1, wherein the timing subsystem measures an internal propagation delay of one or more of the trigger signals.

5. The trigger distribution device of claim 1, wherein the timing subsystem measures a time of receipt of one or more of the trigger signals using a global time base such that the time of receipt enables a determination of a propagation delay on a trigger line.

6. The trigger distribution device of claim 1, wherein the timing subsystem measures an exit time of one or more of the trigger signals using a global time base such that the exit time enables a determination of a propagation delay on a trigger line.

7. The trigger distribution device of claim 1, wherein the timing subsystem generates a calibration trigger signal that enables a determination of a propagation delay on a trigger line.

8. The trigger distribution device of claim 1, wherein the timing subsystem adjusts an internal propagation delay of one or more of the trigger signals.

9. The trigger distribution device of claim 8, wherein the timing subsystem adjusts the internal propagation delay in response to application-specific requirements.

10. The trigger distribution device of claim 9, wherein the internal propagation delay is adjusted in response to a propagation delay on a set of trigger lines that carry one or more of the trigger signals.

11. The trigger distribution device of claim 1, wherein the timing subsystem measures a propagation delay on a set of trigger lines that carry one or more of the trigger signals.

12. The trigger distribution device of claim 1, wherein the time base is a global time base in an ATE system based on a time synchronization protocol.

13. The trigger distribution device of claim 1, wherein the timing subsystem provides an arming function for one or more of the trigger signals.

14. The trigger distribution device of claim 13, wherein the arming function is based on time.

15. The trigger distribution device of claim 13, wherein the arming function is based on a Boolean expression of one or more of the trigger signals.

16. The trigger distribution device of claim 13, wherein the arming function is based on a Boolean expression of one or more of other signals associated with the unit under test and the instruments.

17. The trigger distribution device of claim 13, wherein the arming function is based on a message received via a local area network.

18. The trigger distribution device of claim 13, wherein the arming function includes an arming function associated with each of a set of output ports of the trigger distribution device.

19. A method for trigger distribution comprising providing a time base for handling a connectivity among a set of trigger signals from a unit under test and a set of instruments.

20. The method of claim 19, wherein providing a time base includes generating a timestamp in response to a change in the connectivity.

21. The method of claim 19, wherein providing a time base includes triggering a change in the connectivity in response to a global time.

22. The method of claim 19, wherein providing a time base includes measuring a propagation delay of one or more of the trigger signals.

23. The method of claim 22, wherein measuring a propagation delay includes measuring the propagation delay using a global time base.

24. The method of claim 19, wherein providing a time base includes adjusting a propagation delay of one or more of the trigger signals.

25. The method of claim 24, wherein adjusting a propagation delay includes adjusting the propagation delay in response to application-specific requirements.

26. The method of claim 24, wherein adjusting a propagation delay includes adjusting the propagation delay in response to a propagation delay on a set of trigger lines that carry one or more of the trigger signals.

27. The method of claim 19, wherein providing a time base includes measuring a propagation delay on a set of trigger lines that carry one or more of the trigger signals.

28. The method of claim 19, wherein providing a time base includes providing a global time base based on a time synchronization protocol.

29. The method of claim 19, wherein providing a time base includes providing an arming function for one or more of the trigger signals.

30. The method of claim 29, wherein providing an arming function includes providing an arming function based on a Boolean expression of one or more of the trigger signals.

31. The method of claim 30, wherein providing an arming function includes providing an arming function based on a Boolean expression of one or more of other signals associated with the unit under test and the instruments.

32. The method of claim 29, wherein providing an arming function includes providing an arming function based on a message received via a local area network.
